(19) United States
(12) Patent Application Publication
(10) Pub. No.: US 2007/0244756 A1
(43) Pub. Date: Oct. 18, 2007

(54) INTERNET BUSINESS CO-OP WITH ROTATING BANNERS

(76) Inventor: KAY STUCKI, IDAHO FALLS, ID (US)

Correspondence Address: DYKAS, SHAVER & NIPPER, LLP, P.O. BOX 877, BOISE, ID, 83701-0877, US

(21) Appl. No.: 11/696,123

(22) Filed: Apr. 3, 2007

Related U.S. Application Data
(60) Provisional application No. 60/744,186, filed on Apr. 3, 2006.

(51) Int. Cl. G06Q 30/00

(52) U.S. Cl. 705/14

(57) ABSTRACT

Presented is a system for conducting business on the internet, in which affiliated web commerce sites display advertising of other affiliated web commerce sites on a rotating basis. In the system coupons, hotel booking discounts and credits and advertising are tracked and banner ads for system affiliates are shown on other affiliated sites.

This application claims the priority date of the provisional application entitled INTERNET BUSINESS CO-OP WITH ROTATING BANNERS filed by Kay Stucki on Apr. 3, 2006 with application Ser. No. 60/744,186.

### FIELD OF THE INVENTION

The present invention generally relates to a system for conducting business on the internet, and more particularly to a system for displaying rotating banner ads from one affiliate of a system on the web site of another affiliate.

### BACKGROUND OF THE INVENTION

Currently, Internet usage, and particularly that of the World Wide Web (henceforth referred to as simply the “web”), is growing explosively, particularly as the number of web sites and users that have access to the Internet continue to rapidly and to a great extent, exponentially, expand.

In essence, after establishing a suitable network connection to the Internet, a user at a client computer can easily employ a graphical web browser, such as the Internet Explorer (“IE”) browser presently available from Microsoft Corporation of Redmond, Wash., to connect to a web site and then download a desired web page by simply supplying a specific address (known as a URL or uniform resource locator) of that page to the browser. The URL identifies both an address of the site, in terms of its Internet domain name, and a page of information at that site, in terms of its corresponding file name. Each web site stores at least one, and often times substantially more pages all arranged in a pre-defined hierarchy, generally beginning, at its root, with a so-called “home page”. Each such page is written in HTML (hypertext markup language) form. A page, in this context, refers to content accessed via a single URL, including, e.g., text, graphics and other information specified in HTML code for that particular page. Once a user supplies a URL of interest, the browser operated by that user sends an appropriate command, using a TCP/IP protocol (transmission control protocol/internet protocol), to a remote HTTP (hypertext transport protocol) server, located at the web site and which stores that page, to access and download a corresponding file for that page. In response, the server then sends, using the TCP/IP protocol, a stored file containing HTML code that constitutes that page back to the browser. As the file that constitutes the page itself is received by the browser, the browser interprets and executes the HTML code in that file to properly assemble and render the page on, e.g., a monitor to a user situated at the client computer. Such a page may itself contain HTML commands that reference other files, residing on the same or different web sites, which, when these commands are appropriately interpreted and executed by the browser, result in those files being downloaded and their resulting content properly assembled by the browser into the rendered page. Once all the content associated with the page is rendered, the user can then position his(her) mouse cursor on a suitable hypertext link, button or other suitable user input field (whichever here implements a “hotlink”) displayed on that page and then, through, e.g., a mouse “click”, effectively download a file for and render another desired page in succession until the user has finished his(her) visit to that site, at which point, the user can transition through a hotlink to a page at another site, and so forth. A hotlink specifies a complete web address of an associated page, including a domain name of its hosting web site at which that page is situated. Consequently, by simply and successively positioning and “clicking” his (her) mouse at an appropriate hotlink for each one of a number of desired web pages, the user can readily retrieve an HTML file for each desired page in succession from its corresponding web site and render that page, and, by doing so, essentially effortlessly jump from site to site, regardless of where those sites are physically located.

Ever since their introduction several years ago, HTML and accompanying browser software, now including, e.g., attendant programming languages such as Java and JavaScript languages (“Java” is a registered trademark of Sun Microsystems in Mountain View, Calif.; “JavaScript” is a trademark of Netscape Communications in Mountain View, Calif.), have undergone rather rapid and continual evolution. A major purpose of which has been and continues to be to provide web page authors with an ability to render increasingly rich content through their pages and, as a result, heighten a “user experience” for those users who visit these pages. Consequently, web pages are no longer limited to relatively simple textual displays—as occurred with early versions of HTML and browser software, but can now encompass even full-motion multimedia presentations and interactive games that use rather sophisticated graphics.

The simplicity of browsing the web coupled with the relative low-cost of accessing the Internet, and the relative ease through which a web site can be established are collectively fueling unparalleled growth and diffusion of the Internet itself, web sites and the Internet user community throughout the world. In that regard, by establishing web sites, merchants, vendors and other information providers have an unparalleled opportunity, basically unheard of as little as 5-10 years ago, to reach enormous numbers of potential consumers—regardless of where these consumers reside—at costs far less than previously thought possible. Moreover, given the staggering amount and wide diversity of information currently available on the web, web browsing is becoming so popular a past-time for sufficient numbers of individuals that browsing is beginning to divert significant viewership away from traditional forms of mass entertainment, such as television and cable. While such diversion is relatively small at present, it is likely to rapidly grow. Moreover, given the ease and convenience with which users, situated at their personal computers and with basically nothing more complicated than a few mouse clicks, can effectively interact with remote web sites, electronic commerce, through which goods and services are ordered through the Internet without ever visiting a physical store, is rapidly emerging as a significant sales medium. This medium is likely to significantly challenge and possibly, over a relatively short time, may even alter traditional forms of retailing.

Given the wide and ever-growing reach of the web as a source of consumer information and the increasing consumer acceptance of electronic commerce, advertisers have clearly recognized the immense potential of the web as an effective medium for disseminating advertisements to a consuming public.

Unfortunately, conventional web-based advertising, for various practical reasons—some being technical in nature and others relating to a nature of traditional web advertisements themselves, has generally yielded unsatisfactory results and thus has usually been shunned by most large advertisers. In that regard, several approaches exist in the art for implementing web based advertisements. However, all suffer serious limitations of one form or another that have sharply restricted their desirability and use.

Currently, a predominant format, referred to as a “banner”, for a web advertisement takes the form of a rectangular graphical display situated, typically at a fixed location, in a rendered web page. A banner, which can be static or animated, can be situated anywhere within a rendered web page but most often is situated at a top or bottom, or along a vertical edge of that page. A banner, depending on its size, can extend across an entire page width or length, and usually contains, in a graphical eye-catching form, a name of a product or service being advertised. Increasingly, a banner for a given product or service implements a hotlink to enable a consumer to “click-through” the banner (i.e., generate a mouse click on the banner) in order to transition, via his browser, to a web site maintained by a corresponding advertiser and, from that site, fetch a web page to provide additional information regarding that product or service. Hence, the consumer could easily obtain more information by a click-through; while an advertiser, monitoring counts of such click-throughs that occur in a given period of time, could gain feedback on the effectiveness of the corresponding banner.

What is lacking in the prior art banner advertising system is a way that a web site owner could increase the exposure of his banner by displaying it, even if temporarily, on another website. A system in which many web site owners display banner ads of other web site owners would increase the exposure of each of their ads to more consumers.

### SUMMARY

The invention is an Internet based system for enhanced advertising opportunities for Internet sellers, website owners, and owners of brick and mortar businesses. The system is organized around a host. The host has a domain name and part of this system is that the members of the system obtain a sub-domain, an advertising page, or a coupon page or a combination of all three. For an Internet seller who has a web page and wishes to direct traffic to their site, also called an affiliate member, the system would work as described herein.

The host organization would sell a sub-domain of the host domain name to the affiliate members. The host organization would establish and maintain a number of indexes that are organized and managed by the host. These indexes would list available services and products, and provide a shopping mall front end to web page owners. The indexes could also be arranged to display products and services available in a particular city, region, state, nation or internationally. An affiliate member would join the system and purchase a sub-domain. The affiliates would install their Internet business web page on the sub-domain. On each page of the sub-domain would include at least one header that would be accessible by the host system. There is a banner display as would be displayed in the top header of the page. The system would include a number of affiliates, and each affiliate would also create their own banner display ad. The top header on each page of each affiliates' web pages would display a banner selected from the banners of all of the affiliates. Thus, every time a user opened a web page of an affiliate, they would be presented with a banner ad from a different affiliate. Thus, an affiliate could have exposure of their own banner on all of the other affiliates' web pages and thereby direct more traffic to their site. The top horizontal header may also display more than one banner ad. Each affiliate also selects one or more of the indexes to place a link to their site, and that link is presented by the host organization to browsing shoppers.

The page format on each affiliate's sub-domain may also include side headers in which more rotating banner heads can be placed. Each of the banners will rotate and will display a different banner each time a new page is opened. The display of the banners will be programmed by a queuing system so that every affiliate's banner gets an equal amount of displays.

The Internet system of the invention will also be of use to another type of participant and that is an advertiser. An advertiser is a merchant who has a physical location, also called a brick and mortar store, and is a person who would like to have an Internet presence to advertise their business, and direct enquiries and foot traffic to their business. Membership in this business will also be available to the advertiser who will interact with the system in a similar way as the affiliate member. The advertiser will buy a sub-domain, an advertising page, or have a coupon page, or any combination of the three, prepare a banner ad, select one or more links in one or more indexes to direct traffic to their site, have a banner ad displayed on other system members' web pages, and have a top header and/or side headers available on their site for a listing of other members' banner ads. The advertiser's own web page would provide information about their site and products, directions to their business location, telephone numbers and other appropriate information for a brick and mortar store, or provide a place to present coupons.

The system can be structured with a multi-tiered incentive for affiliates and associates for signing up other members. As referrals sign up, their referring party would receive a referring fee, and this would be multi-level so that some referring fees would travel up the chain to earlier referrers.

Booking Engine Affiliate Banner Exchange. Any booking engine whether it be a Air, Activities, Attractions, Car Rental, Condo Rental, Cruise, Deals, Destinations, Flights, Hotels, Packages, Rail, Transfers and so forth. When the Affiliate Member displays a linking banner on the Affiliate Member's website that links to the booking engine, the booking engine in return allows the Affiliate Member admittance into a rotating advertising banner system. The Affiliate Member's banner will show up from time to time on different parts of the booking engine next to the drop down of the requested hotel or whatever city the Affiliate Member is representing. The Affiliate Member will be given access to a banner building software or he/she may use their own banners and submit them into the rotation and the affiliate member that provided the link will be permitted access to upload his banner into the rotating banner system of the booking engine. Banners may be parked; if there are too many banners submitted to rotate at the very same second or time. They will be on a wait list and be next in line to be [viewed] as the rotation takes its course. The Affiliate may provide a link to the Booking Engine site and get an affiliate fee for any sales generated from their sites banner link, they are then offered a free banner listing or a [for sale/cost pre banner listing] for the exchange of their banner that linked to the booking engine. All based upon approval of the booking engine site.

### BRIEF DESCRIPTION OF THE DRAWINGS

FIG. 1 is a schematic of the system of the invention

FIG. 2 is a view of the home page of the system of the invention.

FIG. 3 is a view of a subject and location search index of the invention.

FIG. 4 is a view of an affiliate web page.

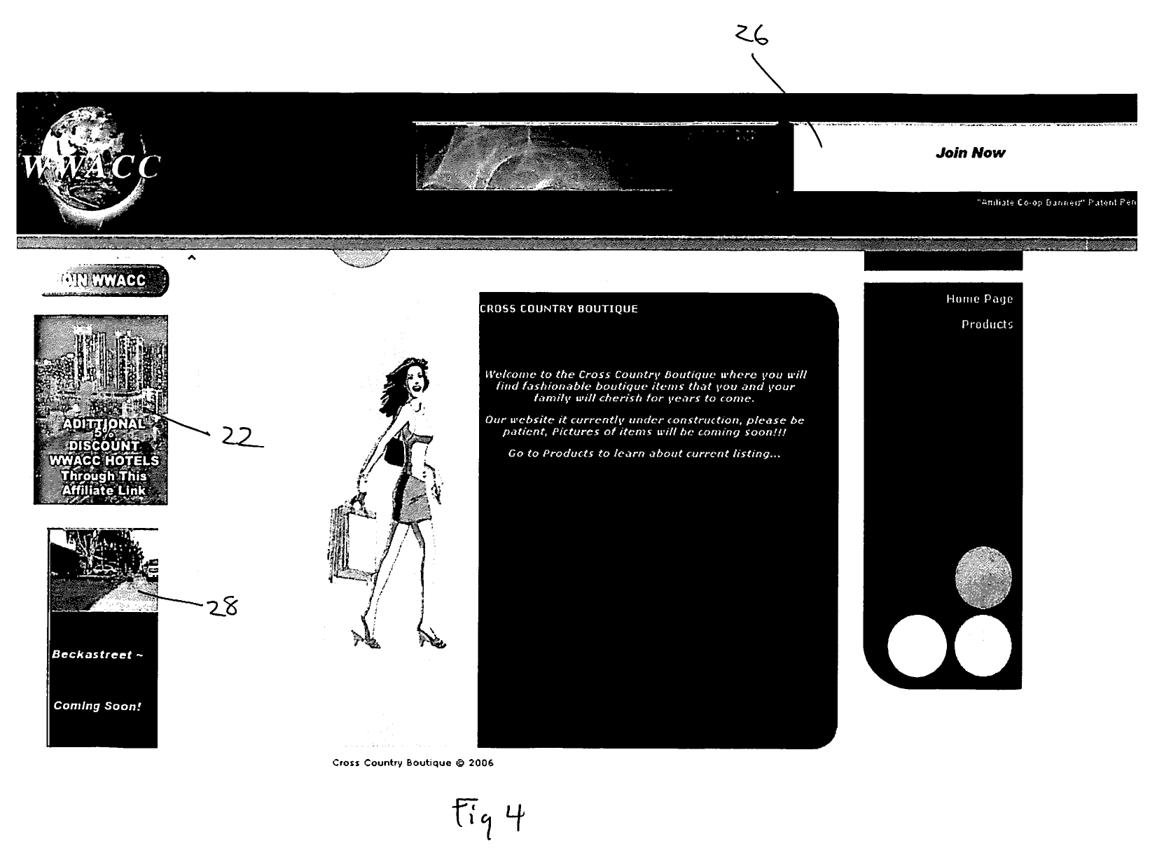

### DESCRIPTION OF THE PREFERRED EMBODIMENT

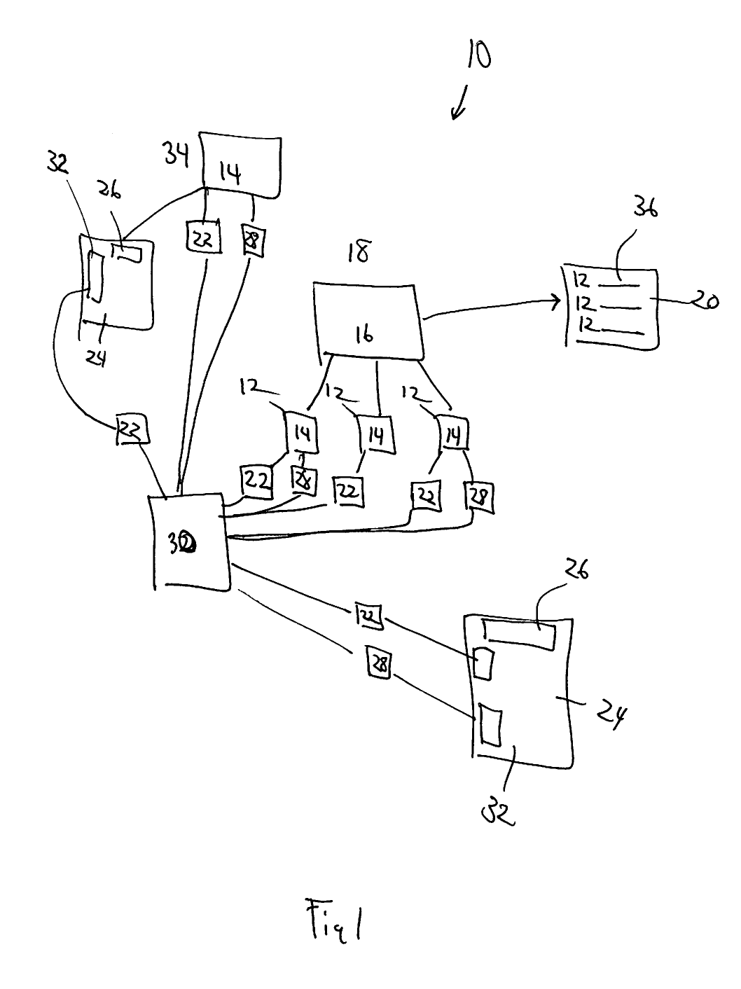

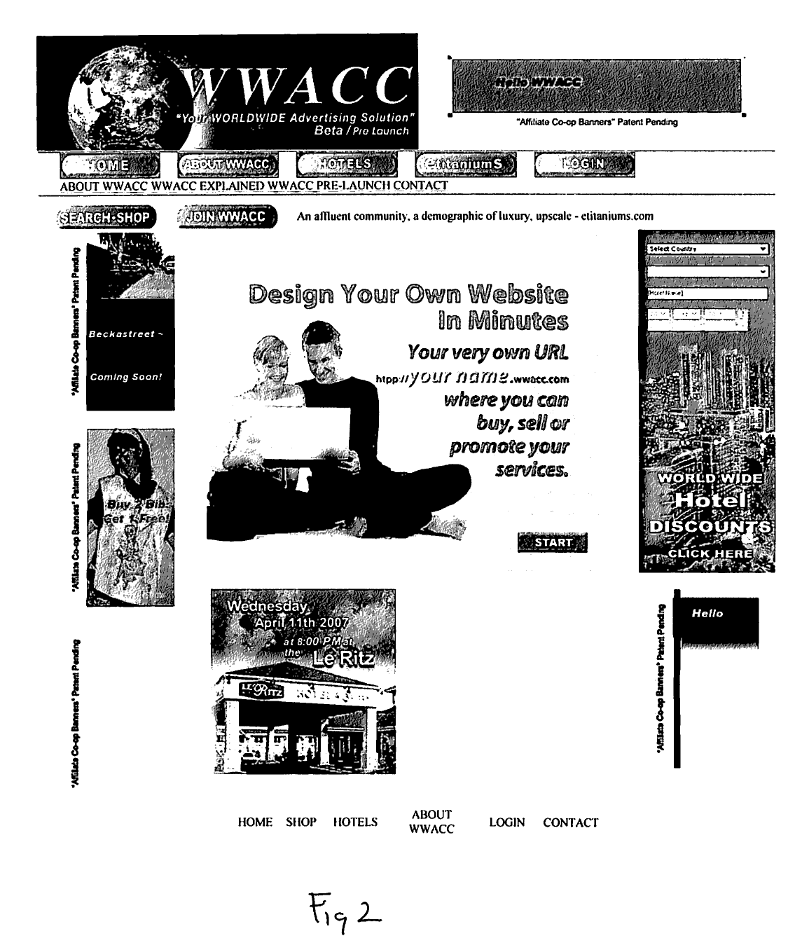

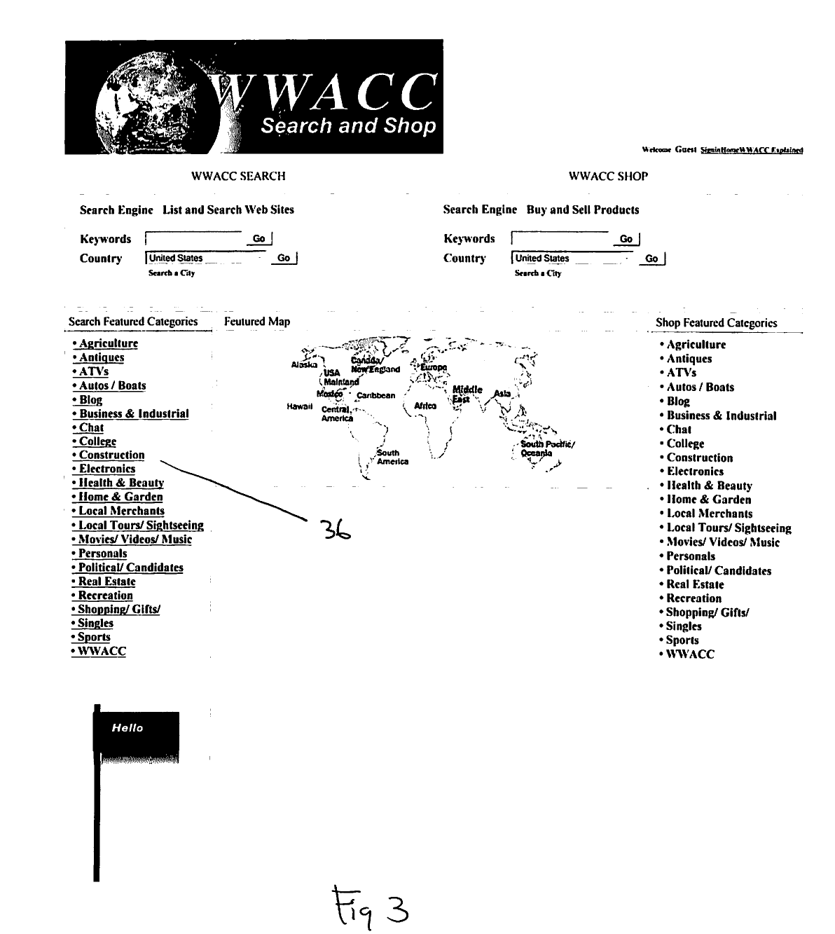

The invention is shown in the FIGS. 1-3. FIG. 1 is a schematic of the system of the invention. The invention is an Internet based system for enhanced advertising opportunities for Internet sellers, website owners, and owners of brick and mortar businesses. The system is organized around a host 18. The host 18 has a domain name 16 and part of this system is that the members, called affiliates 12, of the system obtain a sub-domain 14, an advertising page 22, or a coupon page 28, or a combination of those. For an Internet seller who has a web page 24 and wishes to direct traffic to their site, the system would work as described herein.

The host organization 18 would sell a sub-domain 14 of the host domain name 16 to the affiliate members 12. The host organization 18 would establish and maintain a number of indexes 20 that are organized and managed by the host 18. These indexes 20 would list available services and products, and provide a shopping mall front end to web page owners. The indexes 20 could also be arranged to display products and services available in a particular city, region, state, nation or internationally. An affiliate member 12 would join the system and purchase a sub-domain 14. The affiliates 12 would install their Internet business web page 24 on the sub-domain 14. On each page of the sub-domain 14 would include at least one header 26 that would be accessible by the host system. A banner display ad would be displayed in the top header 26 of the page.

The system would include a number of affiliates 12, and each affiliate would create their own banner display ad 22. The banner display ads of the affiliates 12 would be stored in a database of affiliate banners, 32. The top header 26 on each page of each affiliates' web page 24 would display a banner 22 selected from the banners of all of the affiliates 12. Every time a user opened a web page 24 of an affiliate 12, they would be presented with a banner ad 22 from a different affiliate. Thus, an affiliate 12 could have exposure of their own banner on all of the other affiliates' web pages and thereby direct more traffic to their site.

The top horizontal header 26 may also display more than one banner ad 22. Each affiliate also selects one or more of the indexes 20 to place a link to their site, and that link is presented by the host organization to browsing shoppers.

The page format on each affiliate's sub-domain may also include side headers 32 in which more rotating banner ads 22 can be placed. Each of the banners will rotate and will display a different banner 22 each time a web new page is opened. The display of the banners will be programmed by a queuing system so that every affiliate's banner gets an equal amount of displays.

The Internet system of the invention will also be of use to another type of participant and that is an advertiser 34. An advertiser is a merchant who has a physical location, also called a brick and mortar store, and is a person who would like to have an Internet presence to advertise their business, and direct enquiries and foot traffic to their business. Membership in the system will also be available to the advertiser 34 who will interact with the system in a similar way as the affiliate member 12. The advertiser will buy a sub-domain 14, prepare an advertising page 22, or have a coupon page 28, or any combination of these, prepare a banner ad 22 for the top header 26, select one or more links 36 in one or more indexes 20 to direct traffic to their site, have a banner ad 22 displayed on other system members' web pages 24, and have a top header 26 and/or side headers 32 available on their site for a listing of other members' banner ads. The advertiser's own web page would provide information about their site and products, directions to their business location, telephone numbers and other appropriate information for a brick and mortar store, or provide a place to present coupons.

The system can be structured with a multi-tiered incentive for affiliates and associates for signing up other members. As referrals sign up, their referring party would receive a referring fee, and this would be multi-level so that some referring fees would travel up the chain to earlier referrers.

Booking Engine Affiliate Banner Exchange. Any booking engine, whether it be Air, Activities, Attractions, Car Rental, Condo Rental, Cruise, Deals, Destinations, Flights, Hotels, Packages, Rail, Transfers and so forth. When the Affiliate Member displays a linking banner on the Affiliate Member's website that links to the booking engine, the booking engine in return allows the Affiliate Member admittance into a rotating advertising banner system. The Affiliate Member's banner will show up from time to time on different parts of the booking engine next to the drop down of the requested hotel or whatever city the Affiliate Member is representing. The Affiliate Member will be given access to a banner-building software or he/she may use their own banners and submit them into the rotation and the affiliate member that provided the link will be permitted access to upload his banner into the rotating banner system of the booking engine. Banners may be parked if there are too many banners submitted to rotate at the very same second or time. They will be on a wait list and be next in line to be viewed as the rotation takes its course. The Affiliate may provide a link to the Booking Engine site and get an affiliate fee for any sales generated from their sites banner link, they are then offered a free banner listing or a for sale/cost pre banner listing for the exchange of their banner that linked to the booking engine. All based upon approval of the booking engine site.

An affiliate will register for their own sub domain or URL upon registration with the host organization. The affiliate may then simply login to their affiliate administration page after joining the system and use the available software to create their own web site.

The system includes a Search Engine, among other things. There is a banner on the top header of each affiliate page. The left side bar or side header has one or more banners. These are Rotating Co-op Affiliate Banners. When these are clicked on by a user, they will take the user to a sub domain or sublet domain owner's home page. The top header can have a logo link back to the home page of the host organization, and can also have other banners on the top and banners on the left side bar. These banners are free to all host organization affiliates. All the affiliates have to do is give a special offer or a 5% or more discount to affiliates registered in the system. In doing so, the affiliate may list their products and services free on the system. These co-op banners are included in this free listing concept.

Only affiliates that have joined the system can list on the system. However, anyone in the general public can shop at sites on the system. Only affiliates may create, list and post banners for display on other affiliates sites. An option is that affiliates will give other affiliates a discount or other special offer (i.e.: buy one get one free) in order to list on the system search engine and post banners for free. The affiliate will see there are prices for the general public and prices for affiliates.

If an affiliate already has their own domain and wishes to advertise on the system, they may do so as a “Sublet Domain”. This is done by incorporating their domain address into the system URL. This is done by linking their sub domain address to their existing domain in the Affiliate Admin on host organization. When their listing under a system key word or category search has been found or when someone clicks on their banner, it will take the shopper to the affiliate's sublet link. The customer will be linked to their own domain, with the exception that there will be a top header and left side bar with other Affiliate Rotating Co-op Banners.

The affiliate need not be selling anything to be an affiliate with the system. If the affiliate does not have any thing to sell on the system, the affiliate may purchase their own sub domain as a blog. The affiliate may list their blog on http://blog.host organization. The affiliate may list his blog under the given categories or help create new categories. The affiliate will also be able to post their blog headings on the Rotating Co-op Banners that will circulate in blog.host organization.

The affiliate may wish to make their site a referral site where people just visit to see their business, but not purchase any thing. Maybe the affiliate will show pictures of their landscape, concrete, tile, architecture, or interior decorating jobs and so forth. These types of sites may be listed on the “Search” side of the system. The affiliate may list their business site on search.host organization.

The affiliate will be able to use their referral site to refer people to their site to become affiliates of the system and have them placed in their down line, to build their business.

The affiliate will be able to post affiliate banners on their blog that link to the system or any other site that may pay affiliate fees. The affiliate may post the Hotel Banners on their domain or sub domain referral site or blog that gives a discount to their customers or general public, and as an affiliate, will get an affiliate fee when they book a hotel.

On the Home Page of the system there is a larger banner advertising “Discount Hotels World Wide”. The system or World Wide Activity, Inc., hotel rates are priced to be competitive with sites such as Orbits®, Travelocity®, Priceline®, Hotels® and others. All of these sites have prices that are competitive and vary all the time. On any particular day, one hotel may cost less on one site than the other.

Every sub domain on the system will have the top header and left side bar that include the rotating banners. The left side bar may also have a Discount Hotel Banner that is hard coded. It does not rotate or change. It stays constant. If clicked onto, this banner will direct the customer to the Hotel Booking Engine. If a customer follows the affiliate's sub domain hotel link, he/she will get an additional 5% discount off the already competitive prices found from the home page hotel link. The affiliate will then be paid a commission affiliate fee for any sale made from this direct link.

In addition to the affiliate discount hotel banner link on the sub domain page, the system has also provided a banner found on the affiliate's administration page that can be copied and pasted onto their own site, whether it is a sub domain or sublet domain. The stationary hotel banner and/or the optional copy and paste banners provide an affiliate link to the booking engine. These links recognize the affiliate and will pay an affiliate fee for the referral. Anyone can shop the Hotels and get hotel rates at competitive prices.

In addition to placing banners on affiliates sub domain sites, the system goes one step further by allowing affiliates to place their banners on the Hotel Search Engine. Anyone, including the general public, may surf the system hotel-booking engine. This allows for more exposure from banners viewed while surfers view the hotel booking results. For example, say some one searches Orlando, Fla. There are many hotels there, so they cannot be listed on one page. There may be a drop down search results with 20 or more hotels. On the right hand side of the hotel search result, additional horizontal affiliate banners will be displayed. Every time a new search is made, the banners will refresh and display new banner listings from the rotating co-op banners.

Anyone may shop, but only affiliates may sell/advertise on the system. The shop link is the “door” to shop the system. At the top is the search box that everyone recognizes. Typing in key words here is one way that people will be able to find affiliate pages. When an affiliate joins the system, they will go to their administration page and list the key words that their page can be found under. This not only insures that they can be found in the key words search result pages on the system, but they will also have opportunity to be found on major search engines like Google®, and Yahoo®.

In order to shop and sell in their local areas and natural markets, affiliates can also search and list in the following listings: State and City, College, Country and City, and National or World.

Affiliates also have an option to choose a demographic listing. These categories are search engines in and of themselves inside of the system. If an affiliate has a product or service that would go under one of these categories, they may list there also. This gives affiliates more opportunities to get hits. For example, if the affiliate search in the demographic listing “Real Estate,” the affiliate will find that the search box will only search the system Real Estate listings and not all other listings inside of the system.

The Rotating Co-op Banners will be on all demographic pages. This means more opportunities for advertising and exposure for affiliates.

The affiliate can receive four kinds of one-time affiliate referral fees: 1) New Affiliates, 2) new eTitanium Affiliates, 3) new local merchant advertisers, 4) discount hotel bookings. The affiliate may receive any of these four referral fees in one of two ways. First, the affiliate will refer people and businesses to their the system web site and have them follow the link that pertains to them. Second, if the affiliate already have a web site separate from the system, the affiliate can insert the copy and paste links found in the affiliate the system administration page onto their existing web site and have people and businesses follow the links from there.

Whenever a person or business joins the system or eTitaniums, or makes a hotel booking through their sub domain links or through the links from their independent web site, the affiliate will receive a referral fee whether the affiliate referred them personally or not.

Affiliates may advertise on local State-City or Nation-City listings. The system is world-wide advertising, and also allows the affiliate to list in their local city. Unlike most large search engines, the system has city links. The system is set up to help promote local business as well as world trade. These city links allow affiliates to not only list on the system Search Engine, but on their local city. On the city search, affiliates advertise to their own local community and local affiliates. Many people still enjoy doing business locally, and the system encourages and supports local business, as well as publicizing and putting a given city on the map. If the affiliate are from a country other than the United States, The affiliate may advertise in cities that are listed under their country with the Country/City listing. Here the affiliate will be able to list and also place a “Rotating Co-op Banner”.

Affiliates will be able to submit stories for the magazine and businesses will be able to purchase ad space.

If the affiliate link to a city on the system that has listings, the affiliate will find a page that has categories or listings of local merchants. These listings will then link to a page that is for local merchants to list special offers. Merchants will give offers such as “buy one, get one free” or 15% off. Merchants are giving a discount to draw new business into their stores or establishments. They will also contract to honor the system Card that will soon be offered to all the system Affiliates as a benefit for being an affiliate. For example, a tours business may post an advertisement that offers a 15% discount to the system Affiliates for a shore tour.

Merchants have three main benefits: 1) a page where they have a place to list special offers; 2) access to design software to create display ads, which they can up load; 3) access to software for uploading video or commercials, which they can also up load.

Selected demographics can have advertising directed at them. This demographic includes the person that makes $75,000.00 or more a year and has assets or net worth of $1 million or more. This demographic also includes the mega-rich millionaire or billionaire. The system link to a sister site, for example called www.etitaniums.com will provide an opportunity for the rich to buy, sell, advertise and associate with other elite Titanium Class Affiliates. To be an affiliate of eTitaniums.com, the affiliate must be part of this demographic or have a business or web site that represents luxury products and services. The goal of eTitaniums.com is to cater to and allow advertising for the affluent millionaire class throughout the world by providing exclusive, luxurious, elite listings. This on-line community provides a place for persons or businesses to list to the general public or in the secure section, exclusively to the affluent eTitaniums Affiliates. eTitaniums allows luxury listings from business and personal web sites plus personal, pre-owned or new listings of affiliate's personal items. Examples include: cars, golf carts, helicopters, airplanes, time shares, private islands, horses, hunting trips, grand pianos. All the listings must apply to luxury, upscale criteria. Examples of what will be listed on eTitaniums are given below.

ATV's $12,000 or more

Auto's $75,000 or more

Aviation/planes-Jets $200 and up

Big Boy Toys $14,000 and up

Boats/Yachts $75,000 and up

Houses $1,000.000.00 or more

Real Estate/vacation prosperities $200,000 and up

Luxury Travel by Invitation or Resume, luxury must be agencies “Niche”

RV's $125,000 or more

Investments $100,000 or more

Unique items that are considered the upper scale of it's class

Unique things that qualify as luxury listings, but are over $50

Video Rotating Co-op Banners. eTitaniuns may upload and submit free video banners that will be placed into the rotating co-op banner ads that rotate through out the whole site of eTitaniums.com. These video banners are intended to help create exposure through spontaneous creative marketing of luxury products, whether for sale by businesses or individuals. These videos may have the option to link to the affiliate's web-site. The Sub Domains, Sublet Domains, Affiliate Listings, and Rotating Co-op Banners work the same on eTitaniums.com as they do on the system. However, eTitaniums.com listings and banners do not exchange or rotate inside of the system.

When the affiliate joins the system the affiliate pays a subdomain/sublet domain activation fee, plus a monthly fee. As an affiliate of the system, the affiliate will save money by receiving special offers and discounts from other affiliates and the system merchants. The affiliate will also be promoting their business and increasing online sales through their system web site by being allowed to list free on the system search engine, and within their own city/state listing. The affiliate will be allowed to place free banners that rotate throughout the whole the system web site.

In addition to these benefits, the system may provide significant cash flow to The affiliate for building the affiliate network. the system will pay The affiliate in three ways: 1) through one-time affiliate referral fees each time a person or business becomes a system Affiliate or Merchant Affiliate by enrolling through one of their links. 2) through a residual monthly commission schedule when the system Associates that the affiliate refer, pays their monthly sub domain fee and when they refer someone else to become a the system Associate or merchant (up to seven levels deep), 3) through an affiliate commission each time someone books a hotel through one of their discount hotel links (this will be a percentage of the booking cost).

Any person or business that joins the system or eTitanium through their sub domain (whether the affiliate referred them there or not) will be on their down line and will gain the affiliate an affiliate referral fee and down line affiliate fee.

I claim:

1. An Internet based system for enhanced advertising opportunities for website owners, the system comprising:
a domain name owned by the host organization;
subdomains owned by the host organization to be made available to affiliates, on which is positioned the affiliates business information and at least one host banner window;
a registry of affiliate banners for rotation through the host banner window on each subdomain page; in which
affiliates are website owners who want to direct traffic to their website, and affiliates register and purchase a subdomain from the host organization, and affiliates build an affiliate banner for addition to the registry of affiliate banners for rotational display in said host banner window on each affiliate's site, and in which affiliates install their Internet business web page(s) on the subdomains; wherein
said host banner window on each subdomain page is configured to display in rotation an affiliate banner from the registry of affiliate banners, so that each affiliate has an associated banner displayed by rotation on the subdomain host banner windows shown on all affiliates' web page(s) including their own;
with the banner ads change by rotation with each opening of a page.

2. The system of claim 1 in which the order of rotation of the affiliate banner ads is by random order.

3. The system of claim 1 in which said affiliates pay the host organization to organize and manage the system of rotating affiliate banner ads.

4. The system of claim 1 in which the host organization provides a number of indexes organized and managed by the host organization, of available services and products, with the indexes structured for a particular city, a region, a state, a nation, and international, and for product groupings by category, with each affiliate receiving a link on at least one index that links to their web page.

5. The system of claim 1, which in addition to the top header for display of banner ads, each affiliate of the system displays one or more side bars for display of one or more banner ads of other affiliates, with one or more banner ad being displayed on the side bars.

6. The system of claim 1 that includes discounts to affiliates for products purchased from the host and other affiliates.

7. The system of claim 1, which includes a multi-tiered incentive for signing up other affiliates.

8. The system of claim 1, which includes 24-hour login for affiliates.

9. An Internet based system for enhanced advertising opportunities for advertisers, the system comprising:
the host organization makes available subdomains on which is positioned at least one host banner window, and establishes a registry of banners for rotation through the banner window on each subdomain page;
advertisers are retailers of brick and mortar businesses who want an Internet presence to advertise their business or to post coupons:
advertiser buys a sub-domain from the host;
advertiser creates an ad page(s) for their business, as a sub-domain of the host;
advertiser creates banner ad for display index pages for their city, state, or region, and optionally in top header of affiliates;
index pages of host are configured to display rotation of one or more banners of all advertisers in random order;
top header of host is configured to display rotation of one or more banners of all affiliates and advertisers in random order and top header of host is on all affiliates' sites and on advertiser page(s);
each advertiser has their own banner displayed on affiliates' web page(s);
the banner ads displayed on affiliates' sites, change with each opening of a page;
advertisers pay host to organize and manage the system of advertising rotation.

10. The Internet based system of claim 9 in which an advertiser can offer coupons and change them himself 24-7, have his own login and password, and can change the expiration date, change the offer, and redesign the advertisement.

11. An Internet based system for enhanced advertising opportunities for website owners, the system comprising:
a domain name owned by the host organization;
a booking engine owned by the host organization;
the host organization makes available subdomains on which is positioned at least one host banner window and a link and post to a booking engine, and establishes a registry of banners for rotation through the banner window on each subdomain page;
affiliates are website owners who want to direct traffic to their website;
advertisers are business owners who want an internet presence to post coupons, and post information about their brick and mortar businesses;
affiliates and advertisers register and purchase a sub-domain from the host organization;
affiliates and advertisers build a banner for addition to the registry of banners for rotation;
affiliates and advertisers install their Internet business web page(s) on the sub-domain page or pages;
at least one banner window on each subdomain page is configured to display rotation of one or more banners of all affiliates in random order, and subdomain pages have a banner and or a link to the booking engine;
each affiliate has their own banner displayed by rotation on the subdomain banner windows shown on all affiliates' web page(s) including their own:
the banner ads change by rotation with each opening of a page;
the affiliates and advertisers benefit by the cooperative banner posting, and from finder fees for hits and/or purchase at the booking engine, and the host organization gets increased traffic to the booking engine.

12. The system of claim 11, in which the booking engine includes banners in the dead spaces adjacent to the booking information, which displays the referring sites banner ad.

13. A number of indexes of available services and products, with the indexes structured for a particular city, a region, a state, a nation, and international, and for product groupings, like clothes, watches, shoes, tools, or services.

14. The system of claim 3, which in addition to the top header for display of banner ads, each affiliate of the system displays one or more side bars for display of one or more banner ads of other affiliates and advertisers, with one or more banner ad being displayed on the side bars.
